(19) United States
(12) Patent Application Publication
(10) Pub. No.: US 2025/0187100 A1
(43) Pub. Date: Jun. 12, 2025

(54) METHOD OF RESISTANCE SPOT WELDING AND RESISTANCE SPOT WELDING APPARATUS

(71) Applicant: FUTABA INDUSTRIAL CO., LTD., Okazaki-shi (JP)

(72) Inventors: Keigo Yasuda, Okazaki-shi (JP); Shoichi Kawano, Okazaki-shi (JP)

(21) Appl. No.: 18/974,136

(22) Filed: Dec. 9, 2024

(30) Foreign Application Priority Data
Dec. 11, 2023 (JP) 2023-208610

(51) Int. Cl. B23K 11/11; B23K 11/00; B23K 11/24

(52) U.S. Cl. CPC B23K 11/115; B23K 11/002; B23K 11/24

(57) ABSTRACT

A workpiece prepared by layering two or more metallic plates is welded by using a resistance spot welding apparatus. A first current application control is performed on a pair of electrodes that holds the workpiece such that a first current flows between the pair of electrodes. Subsequently, a second current application control is performed on the pair of electrodes such that a current flowing between the pair of electrodes decreases from the first current to a second current that is smaller than the first current. Subsequently, a third current application control is performed on the pair of electrodes such that a current flowing between the pair of electrodes increases from the second current to a third current that is greater than the second current. Subsequently, a fourth current application control is performed on the pair of electrodes such that a fourth current flows between the pair of electrodes.

### CROSS-REFERENCE TO RELATED APPLICATIONS

This application claims the benefit of Japanese Patent Application No. 2023-208610 filed on Dec. 11, 2023 with the Japan Patent Office, the entire disclosure of which is incorporated herein by reference.

### BACKGROUND

The present disclosure relates to a method of resistance spot welding and a resistance spot welding apparatus.

In order to efficiently form a welding nugget while inhibiting generation of a spatter in resistance spot welding, a technique to supply a constant current before applying a main current is already known. Japanese Unexamined Patent Application Publication No. 2021-079410 discloses an execution of a current application control, by which a constant current is supplied for a prescribed time period after an initial current application for gradually increasing a welding current, followed by a supply of a larger constant current.

### SUMMARY

In resistance spot welding, when welding a workpiece prepared by layering two or more metallic plates, inconsistencies in heat generation between the metallic plates may lead to a deterioration of the quality of welding. Such inconsistencies in heat generation may be caused by a difference in resistance between the metallic plates. The difference in resistance may be caused by, for example, differences in tensile strength and plate thickness between the metallic plates.

If inconsistencies in heat generation occurs between the metallic plates, an uneven welding nugget is formed in the workpiece which leads to a possibility of insufficient weld penetration in some part of the metallic plates.

Considering the above, according to one aspect of the present disclosure, it is preferable to provide a technique that can achieve a high quality welding when performing resistance spot welding on a workpiece prepared by layering two or more metallic plates.

According to one aspect of the present disclosure, a method of resistance spot welding for welding a workpiece prepared by layering two or more metallic plates by using a resistance spot welding apparatus is provided. The resistance spot welding apparatus includes a pair of electrodes.

The method of resistance spot welding includes performing a first current application control on the pair of electrodes such that a first current flows between the pair of electrodes in a state where the workpiece is held between the pair of electrodes at both ends of the workpiece in a layering direction of the two or more metallic plates. The method of resistance spot welding may further include performing a second current application control on the pair of electrodes such that a current flowing between the pair of electrodes decreases from the first current to a second current that is smaller than the first current. The second current application control may be performed subsequent to the first current application control.

The method of resistance spot welding may further include performing a third current application control on the pair of electrodes such that a current flowing between the pair of electrodes increases from the second current to a third current that is greater than the second current. The third current application control may be performed subsequent to the second current application control.

The method of resistance spot welding may further include performing a fourth current application control on the pair of electrodes such that a fourth current flows between the pair of electrodes. The fourth current application control may be performed subsequent to the third current application control. The fourth current may be a constant current. The first current may be a constant current smaller than the fourth current. The third current may be greater than the fourth current.

According to this method of resistance spot welding, warpage of the metallic plates can be facilitated by the first and second current application controls. The warpage helps create a condition where a current application path is concentrated in a narrow area. Furthermore, shunting of the current to the surfaces of the metallic plates can be facilitated by temporarily supplying a large current through the third current application control, which makes it possible to achieve a melt of a wide range of the metallic plates in the layering direction. This melt inhibits inconsistencies of the properties of the materials in the layering direction. Thus, inconsistencies in the melt between the metallic plates can be inhibited when finishing the welding of the workpiece in the fourth current application control.

Thus, according to this method of resistance spot welding, it is possible to achieve a high quality welding of the workpiece prepared by layering two or more metallic plates. Furthermore, an excellent welding can be achieved by restricting the fourth current to be a relatively small current in the fourth current application control. Therefore, according to this method of resistance spot welding, a high quality welding can be achieved while inhibiting a spatter.

According to one aspect of the present disclosure, the two or more metallic plates may include at least two metallic plates having resistances, tensile strengths, or plate thicknesses different from one another. When the metallic plates include metallic plates having resistances different from one another, due to such a difference in resistance, heat generation and the melt may be inconsistent between the metallic plates.

Metallic plates having different strengths have resistances different from one another. Metallic plates having different plate thicknesses have resistances different from one another. Thus, in a case where two or more metallic plates include metallic plates having tensile strengths or plate thicknesses different from one another, there may be a possibility that the melt is inconsistent between the metallic plates.

According to one aspect of the present disclosure, the aforementioned first, second, third, and fourth current application controls can inhibit inconsistencies in the melt between the metallic plates caused by the difference in resistance, tensile strength, or plate thickness. This improves the welding quality.

According to one aspect of the present disclosure, the workpiece may include a workpiece in which two metallic plates among the two or more metallic plates situated at the both ends of the workpiece in the layering direction have resistances, tensile strengths, or plate thicknesses different from one another. The aforementioned method of resistance spot welding is effective in improving the quality of welding such a workpiece.

According to one aspect of the present disclosure, the workpiece may include a workpiece prepared by layering the two or more metallic plates such that the resistance, the tensile strength, or the plate thickness of the metallic plates increase or decrease in the layering direction. According to one aspect of the present disclosure, the workpiece may include a workpiece in which, among the two or more metallic plates, a tensile strength of a first metallic plate situated at a first end of the workpiece in the layering direction is different from a tensile strength of a second metallic plate situated in the middle of the workpiece in the layering direction; a tensile strength of a third metallic plate situated at a second end of the workpiece in the layering direction, which is an opposite end from the first end, is smaller than a sum of the tensile strength of the first metallic plate and the tensile strength of the second metallic plate; and the tensile strength of the second metallic plate situated in the middle of the workpiece in the layering direction is a tensile strength of a metallic plate held between the first metallic plate and the third metallic plate situated at the both ends of the workpiece among the two or more metallic plates, or a sum of tensile strengths of one or more metallic plates held between the first metallic plate and the third metallic plate among the two or more metallic plates. The aforementioned method of resistance spot welding can improve the quality of welding on the workpiece that satisfies such conditions.

According to one aspect of the present disclosure, a ratio H1/H2 of a total plate thickness H1 which is a sum of thicknesses of the two or more metallic plates of the workpiece in the layering direction to a thickness H2 which is a thickness of a metallic plate having a smaller thickness among two metallic plates situated at the both ends of the workpiece in the layering direction may be 3.5 or more. The aforementioned method of resistance spot welding can improve the quality of welding on the workpiece that satisfies such conditions.

According to one aspect of the present disclosure, the workpiece may include a workpiece having a difference in strength of 445 MPa or more on the both ends. According to one aspect of the present disclosure, the workpiece may include a workpiece having a difference in strength of 255 MPa or more on the both ends, and a ratio of strength of 4.29 or more. Here, the difference in strength at the both ends is a difference in tensile strengths of the two metallic plates situated at the both ends of the workpiece in the layering direction. The ratio of strength is a value obtained by dividing a sum of the tensile strengths of the two or more metallic plates of the workpiece by a tensile strength of a metallic plate having a smaller tensile strength among the two metallic plates situated at the both ends of the workpiece in the layering direction. The aforementioned method of resistance spot welding can improve the quality of welding on the workpiece that satisfies such conditions.

According to one aspect of the present disclosure, the two or more metallic plates may include a high-tensile steel plate. The method of resistance spot welding of the present disclosure can improve the quality of welding on the workpiece including the high-tensile steel plate.

According to one aspect of the present disclosure, a resistance spot welding apparatus for welding a workpiece prepared by layering two or more metallic plates may be provided. The resistance spot welding apparatus may include a pair of electrodes, and a controller. The pair of electrodes may be disposed to hold the workpiece at both ends of the workpiece in the layering direction of the two or more metallic plates.

The controller may be configured to control current application between the pair of electrodes. The controller may be configured to perform a first current application control on the pair of electrodes such that a first current flows between the pair of electrodes that holds the workpiece.

The controller may be configured to perform a second current application control on the pair of electrodes such that a current that flows between the pair of electrodes decreases from the first current to a second current that is smaller than the first current. The second current application control may be performed subsequent to the first current application control.

The controller may be configured to perform a third current application control on the pair of electrodes such that a current that flows between the pair of electrodes increases from the second current to a third current that is greater than the second current. The third current application control may be performed subsequent to the second current application control.

The controller may be configured to perform a fourth current application control on the pair of electrodes such that a fourth current flows between the pair of electrodes. The fourth current application control may be performed subsequent to the third current application control. The fourth current may be a constant current. The first current may be a constant current smaller than the fourth current. The third current may be greater than the fourth current.

This resistance spot welding apparatus can improve the quality of welding likewise the aforementioned method of resistance spot welding.

### BRIEF DESCRIPTION OF THE DRAWINGS

Example embodiments of the present disclosure will be described hereinafter with reference to the accompanying drawings, in which:

FIG. 1 is a schematic diagram of a resistance spot welding apparatus;

FIG. 2 is a block diagram showing an electrical configuration of the resistance spot welding apparatus;

FIG. 3 is a graph showing a typical current profile;

FIG. 4 is a flowchart showing a welding process including current controls;

FIG. 5 is a graph showing a specific example of the current profile of a specific workpiece;

FIG. 6A is a schematic cross sectional diagram of a workpiece describing a first stage of an initial current application;

FIG. 6B is a schematic cross sectional diagram of the workpiece describing a second stage of the initial current application;

FIG. 7A is a schematic cross sectional diagram of a workpiece describing a melt caused by a large current application;

FIG. 7B is a cross sectional diagram of a workpiece describing a growth of a welding nugget in a main current application;

FIG. 7C is a cross sectional diagram of a workpiece describing a growth of a welding nugget in the main current application;

FIG. 8A is a diagram describing a modified example of a current profile;

FIG. 8B is a diagram describing a modified example of the current profile;

FIG. 8C is a diagram describing a modified example of the current profile;

FIG. 9A is a diagram describing a modified example of the current profile;

FIG. 9B is a diagram describing a modified example of the current profile; and

FIG. 9C is a diagram describing a modified example of the current profile.

### DETAILED DESCRIPTION OF EXEMPLARY EMBODIMENTS

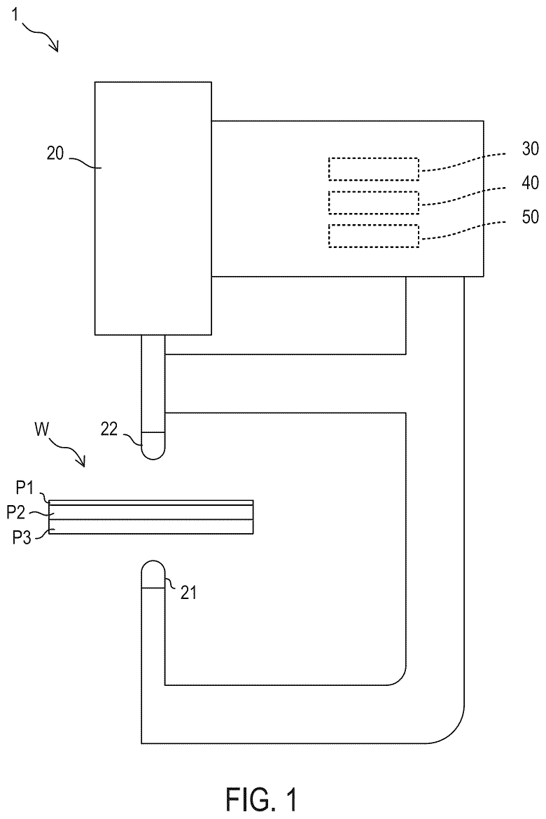

A resistance spot welding apparatus 1 shown in FIG. 1 is configured to weld a workpiece W, prepared by layering two or more metallic plates, by resistance spot welding.

The workpiece W may include two or more steel plates as the metallic plates. The workpiece W may include at least two steel plates having different resistances. The workpiece W may include at least two steel plates having different tensile strengths. The workpiece W may include at least two steel plates having different plate thicknesses. The higher the tensile strength of the steel plate is, the larger the resistance of the steel plate is. The larger the plate thickness of the steel plate is, the larger the resistance of the steel plate is. The “resistance” in the present disclosure is an electric resistance.

An example of the workpiece W shown in FIG. 1 is a workpiece including three steel plates layered on one another. The workpiece W includes a first steel plate P1, a second steel plate P2, and a third steel plate P3.

The first steel plate P1 may be, but not limited to, a hot-dip galvanized steel sheet, for example. The first steel plate P1 may be a high-tensile steel plate having a tensile strength of 440 MPa (mega pascal) or more, for example. The first steel plate P1 may be an SCGA440 steel plate having a thickness of 1.4 mm, for example.

The second steel plate P2 may be, but not limited to, a hot-dip galvanized steel sheet, for example. The second steel plate P2 may be a high-tensile steel plate having a tensile strength of 1180 MPa or more, for example. The second steel plate P2 may be an SCGA1180 steel plate having a thickness of 1.4 mm, for example. The high-tensile steel plate having such an extremely high tensile strength is also called a super-high tension material.

The third steel plate P3 may be, but not limited to, a cold rolling steel plate, for example. The third steel plate P3 may be a high-tensile steel plate having a tensile strength of 1470 MPa or more, for example. The third steel plate P3 may be a SPC1470 steel plate having a thickness of 2 mm, for example.

In the example of the workpiece W shown in FIG. 1, the first steel plate P1, the second steel plate P2, and the third steel plate P3 are layered in this order. Hereinafter, the direction in which two or more metallic plates included in the workpiece W are layered is called a layering direction. The layering direction corresponds to the normal directions of the first steel plate P1, the second steel plate P2, and the third steel plate P3 as well as the normal direction of the surface of the workpiece. The layering direction corresponds to the thickness directions of the first steel plate P1, the second steel plate P2, and the third steel plate P3 as well as the thickness direction of the workpiece.

The resistance spot welding apparatus 1 includes a resistance welding device 20. The resistance welding device 20 welds the two or more metallic plates disposed as the workpiece W by resistance spot welding in the layering direction.

The resistance welding device 20 includes a first electrode 21 and a second electrode 22. The first electrode 21 is disposed below the workpiece W. The second electrode 22 is disposed above the workpiece W such that the workpiece W is held between the first electrode 21 and the second electrode 22 in the layering direction. The first electrode 21 is movable in up-down directions relative to the second electrode 22.

The first electrode 21 and the second electrode 22 each contact the workpiece W at the time of welding. The first electrode 21 contacts the third steel plate P3 which is the metallic plate located as the lowermost layer of the workpiece W. The second electrode 22 contacts the first steel plate P1 which is the metallic plate located as the uppermost layer of the workpiece W. The first electrode 21 and the second electrode 22 hold both sides of the workpiece W in the layering direction so as to apply a pressure. In this state, a welding current is supplied between the first electrode 21 and the second electrode 22 and flows through the workpiece W. The workpiece W is welded by resistance heating generated from the welding current.

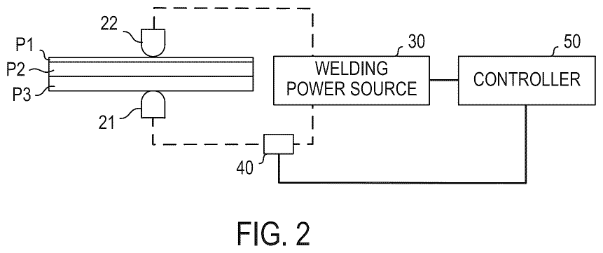

As shown in FIG. 2, the resistance spot welding apparatus 1 includes a welding power source 30, a current sensor 40, and a controller 50 as elements of an electric system for the resistance welding device 20.

The welding power source 30 is configured to supply the welding current between the first electrode 21 and the second electrode 22. The current sensor 40 is disposed on a track between the welding power source 30 and the first electrode 21 or on a track between the welding power source 30 and the second electrode 22. The current sensor 40 is configured to detect a current I supplied between the first electrode 21 and the second electrode 22, and input the detected signal into the controller 50. The current I is the welding current mentioned above.

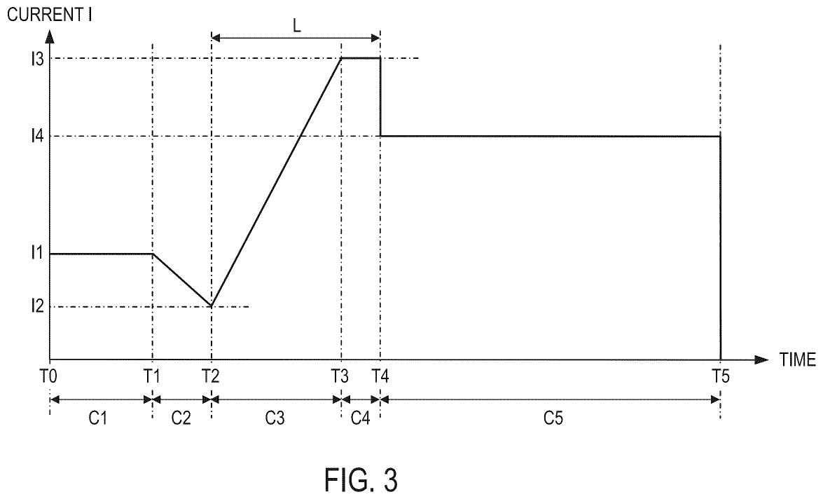

The controller 50 controls current application between the first electrode 21 and the second electrode 22 by controlling the welding power source 30. Specifically, as a current application control, the controller 50 is configured to control the current I that flows between the first electrode 21 and the second electrode 22 such that the current I changes in accordance with the current profile shown in FIG. 3.

More specifically, the controller 50 is configured to perform a feedback control of the current I that flows between the first electrode 21 and the second electrode 22 based on the current I detected by the current sensor 40. Hereinafter, the first electrode 21 and the second electrode 22 are collectively referred to as a pair of electrodes 21, 22.

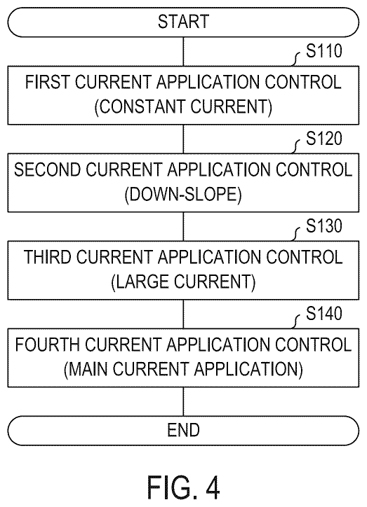

The controller 50 initiates the control process shown in FIG. 4 when a welding initiation command to weld the workpiece W is inputted via a manipulator which is not illustrated. In the control process, the controller 50 controls the current I between the pair of electrodes 21, 22 such that the melting current changes in accordance with the current profile shown in FIG. 3. This control helps achieve a good resistance spot welding on the workpiece W.

Specifically, the controller 50 performs a first current application control (S110) on the pair of electrodes 21, 22 for a time period C1, which is a time period from a welding initiation point T0 for welding the workpiece W to a first point T1 where a given duration of time has passed since the welding initiation point T0. In the time period C1, the first current application control is performed such that a first current I1 flows between the pair of electrodes 21, 22 that holds the workpiece W. The first current I1 is a constant current.

Subsequent to the first current application control (S110), the controller 50 performs a second current application control (S120) on the pair of electrodes 21, 22 for a time period C2, which is a time period from the first point T1 to a second point T2. In the time period C2, the second current application control is performed such that the current I that flows between the pair of electrodes 21, 22 decreases from the first current I1 to a second current I2, which is smaller than the first current I1. The second current I2 is larger than zero.

Subsequent to the second current application control (S120), the controller 50 performs a third current application control on the pair of electrodes 21, 22 for a time period C3, which is a time period from the second point T2 to a third point T3, and for a time period C4, which is a time period from the third point T3 to a fourth point T4 (S130).

In the time period C3, the third current application control is performed such that the current I that flows between the pair of electrodes 21, 22 increases from the second current I2 to a third current I3, which is larger than the second current I2. In the time period C4, the third current application control is performed such that the current I that flows between the pair of electrodes 21, 22 maintains the third current I3.

Subsequent to the third current application control (S130), the controller 50 performs a fourth current application control (S140) on the pair of electrodes 21, 22 for a time period C5, which is a time period from the fourth point T4 to a fifth point T5. In the time period C5, the fourth current application control is performed such that a fourth current I4, which is smaller than the third current I3, flows between the pair of electrodes 21, 22.

In the time period C5, the fourth current application control is performed such that a constant current flows between the pair of electrodes 21, 22 as the fourth current I4. As mentioned above, also in the time period C1 which is from the welding initiation point T0 to the first point T1, the current between the pair of electrodes 21, 22 is controlled such that a constant current flows between the pair of electrodes 21, 22 as the first current I1. The first current I1 is smaller than the fourth current I4 for a reason explained later.

In the time periods C3 and C4 from the second point T2 to the fourth point T4, the current between the pair of electrodes 21, 22 is controlled such that a current larger than the fourth current I4 flows between the pair of electrodes 21, 22 as the third current I3 for a reason explained later.

The controller 50 continuously performs these first, second, third, and fourth current application controls as a consecutive current application control from the point T0, and, at the fifth point T5, stops the current application between the pair of electrodes 21, 22. The controller 50 then ends the control process. The resistance spot welding on the workpiece W is completed at the fifth point T5.

Now, an object of the aforementioned current application control in accordance with the current profiles will be explained. The current application from the welding initiation point T0 to the first point T1 in the present embodiment corresponds to a first stage of an initial current application, and is performed to heat the workpiece W by the resistance heating within the workpiece W to the extent that the workpiece W does not melt. The first current I1 and the length of the time period C1, which is from the point T0 to the point T1, are determined within an extent that the workpiece W does not melt.

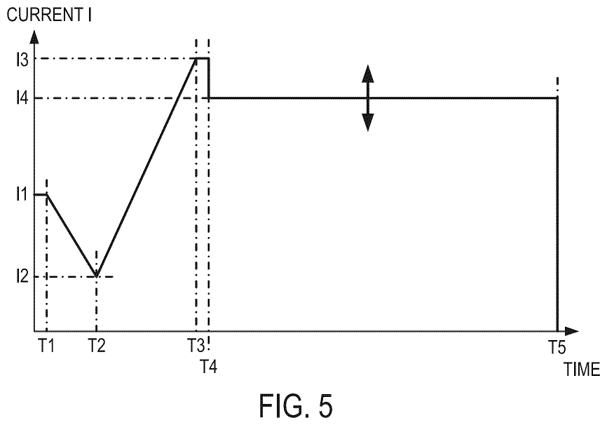

FIG. 5 shows a specific example of the current profile that is applicable when the workpiece W is a workpiece (hereinafter referred to as focused workpiece) including an SCGA440 steel plate having a thickness of 1.4 mm as the first steel plate P1, an SCGA1180 steel plate having a thickness of 1.4 mm as the second steel plate P2, and an SPC1470 steel plate having a thickness of 2 mm as the third steel plate P3. The pressure applied between the pair of electrodes 21, 21 is 5.51 kN (kilonewtons).

The horizontal axis in FIG. 5 represents hours. The vertical axis in FIG. 5 represents the current I. The graph in FIG. 5 shows ratios of lengths of time between the points TO, T1, T2, T3, T4, and T5, and ratios between the current I1, I2, I3, and I4 in detail provided that the time and the current I at the origin are zero.

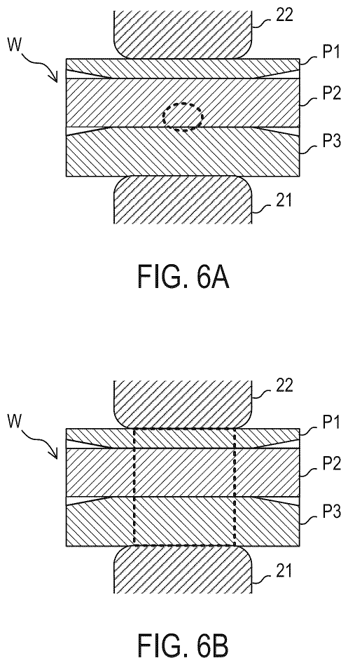

FIG. 6A conceptually shows that the interior of the workpiece W is heated at the first stage of the initial current application. In FIG. 6A, the dotted line conceptually shows a portion of the workpiece W that is heated in a case where the resistance of the second steel plate P2 is higher than the resistance of the first steel plate P1, and the resistance of the third steel plate P3 is higher than the resistance of the second steel plate P2. The portion shown with the dotted line corresponds to the center of resistance of the workpiece W. This example of the combination of the first steel plate P1, the second steel plate P2, and the third steel plate P3 includes the combination of the first steel plate P1, the second steel plate P2, and the third steel plate P3 in the aforementioned focused workpiece.

The first stage of the initial current application is carried out not only for heating a center of resistance, but also for generating a warpage in the metallic plates included in the workpiece W to limit a current application path in the workpiece W to a narrow area.

The warpage of the metallic plates described herein is a warpage generated such that the metallic plates adjacent to each other in the layering direction separates more from each other in the layering direction as the distance from the center of the current application path between the first electrode 21 and the second electrode 22 increases.

FIG. 6A shows that the warpage of the first steel plate P1 causes the first steel plate P1 and the second steel plate P2 to separate from each other in areas away from the center of the current application path. Likewise, FIG. 6 shows that the warpage of the third steel plate P3 causes the second steel plate P2 and the third steel plate P3 to separate from each other in areas away from the center of the current application path.

Such separations of the metallic plates limit the current application path, which causes the current to flow intensively in the interior of the workpiece W. Hereinafter, an intensive flow of the current between the pair of electrodes 21, 22 at a desirable current density through a limited area in the workpiece W is called current concentration.

The current application from the first point T1 to the second point T2 corresponds to the second stage of the initial current application, which is carried out to entirely heat an area in the workpiece W held between the first electrode 21 and the second electrode 22 with a gradual heat input to the workpiece W.

The dotted lines in FIG. 6B conceptually shows that, in the second stage of the initial current application, the heat spreads from the center of resistance, and the area in the workpiece W held between the first electrode 21 and the second electrode 22 is entirely heated.

This heating serves to stably form the warpage of the metallic plates. In other words, by providing a step to gradually decrease the current I as seen in the current control from the first point T1 to the second point T2, the warpage of the metallic plates is stably generated and the current concentration is stably achieved.

In the present embodiment, the controller 50 controls a current that flows between the pair of electrodes 21, 22 based on the detected signal delivered from the current sensor 40. However, when the warpage of the metallic plates cannot be stably formed, the current density at the time when the current flows in the layering direction of the workpiece W changes, which then changes the mode of heat generation. Accordingly, in order to achieve the stable current concentration, it is important to perform the current control to include a down-slope between the first point T1 and the second point T2 (S120).

The current application from the second point T2 to the fourth point T4 is for facilitating shunting of the current to a surface of a metallic plate having a relatively low resistance by supplying a large current, and for achieving heat generation and melt over the entirety of the workpiece W from its upper surface to its lower surface between the pair of electrodes 21, 22. Hereinafter, the time periods C3 and C4 from the second point T2 to the fourth point T4 are also collectively called a large current section L.

When a steel plate having a relatively low resistance, such as the first steel plate P1 of the focused workpiece, exists on the surface of the workpiece W and a large current is not supplied, there is a possibility that joule heat generated on this low resistance steel plate is not sufficient and thus welding of the first steel plate P1 ends up to be insufficient. If a large current is supplied, it is possible to inhibit a deterioration of welding quality due to such insufficient heat generation on the steel plate having a relatively low resistance.

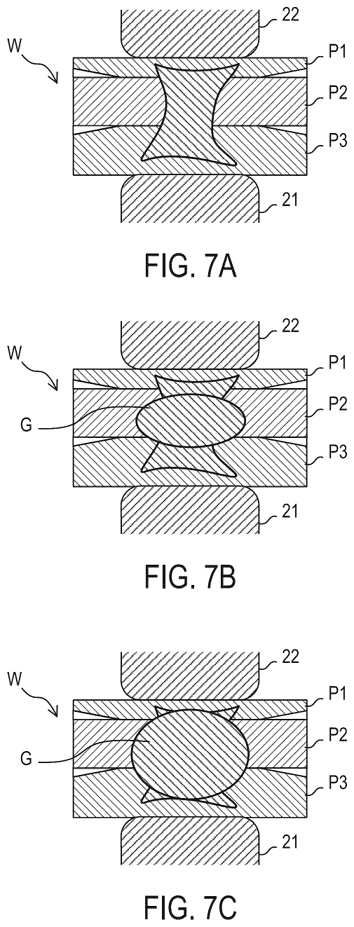

FIG. 7A shows that, due to supply of a large current in the third current application control, a broad range of melt is generated between the pair of electrodes 21, 22, which causes material fusion between adjacent steel plates of the first steel plate P1, the second steel plate P2, and the third steel plate P3. The material fusion mitigates the differences in resistance between the metallic plates.

The current application from the fourth point T4 to the fifth point T5 corresponds to the main current application and is performed to finish the welding of the workpiece W. The fourth current I4, and the length of time of the time period C5 from the point T4 to the point T5 (that is, the main current application time) are determined so that an appropriate welding nugget G is formed in the workpiece W.

The main current application serves to spread the melt in the workpiece W from the center of resistance to the circumference and to form an appropriate welding nugget G in the workpiece W. Since the difference in resistance is mitigated by the material fusion caused by the supply of a large current in the previous step, the melt in the workpiece W spreads more uniformly than in a case where the third current application control is omitted. As a result of this, an appropriate welding nugget G is formed in the workpiece W.

FIG. 7B and FIG. 7C show that the welding nugget G gradually grows as a result of the main current application. As shown in FIG. 7C, a spread of the welding nugget G over the entirety of the metallic plates (the first steel plate P1, the second steel plate P2, and the third steel plate P3) in the workpiece W results in excellent welding quality.

To be more specific, in the present embodiment, since the current concentration is achieved, effective heat generation and melt of the metallic plates can be achieved, and an appropriate welding nugget G can be formed with a relatively small current.

Moreover, in the present embodiment, since the current concentration can be stably achieved in the process until the second stage of the initial current application, a current tolerance in the main current application can be increased. In other words, a relatively wide current can be allowed (tolerated) as the fourth current I4 for achieving an appropriate welding. In FIG. 5, a thick arrows on the fourth current I4 means that the tolerance of the fourth current I4 is large.

Furthermore, in the present embodiment, since the third current application control helps achieve a broad range of material fusion in the workpiece W in the layering direction, a spatter is inhibited with a small current in the main current application, and an excellent welding can be achieved.

The resistance spot welding apparatus 1 and the method of the resistance spot welding of the present embodiment have been explained above. This method of welding functions in a productive manner when welding the workpiece W prepared by layering two or more metallic plates each having a different resistance. Examples of the metallic plates having different resistances include metallic plates having different tensile strengths, and metallic plates having different plate thicknesses.

In the workpiece W, when there is a difference in resistance between the metallic plates, the resistance heating is small in a portion having a low resistance compared to other portions. In the present embodiment, shunting of the current to the metallic plates having relatively low resistances can be facilitated by supplying a large current. Moreover, the difference in resistance can be mitigated by causing the material fusion between the metallic plates disposed adjacent to each other. Accordingly, it is possible to weld two or more metallic plates having different resistances in an excellent manner.

The method of the resistance spot welding provided in accordance with the current profile including the aforementioned large current section L particularly effectively functions when a workpiece W including three metallic plates as exemplified by a combination of the first steel plate P1, the second steel plate P2, and the third steel plate P3 satisfies at least any one of a first condition, a second condition, a third condition, or a fourth condition each expressed in the following inequalities.
First condition: X1<X3
Second condition: X1>X2 and (X1+X2)>X3
Third condition: X1<X2 and (X1+X2)>X3
Fourth condition: X1≥X2>X3

Here, the premise is that, in the workpiece W, the first metallic plate is the metallic plate having the tensile strength X1, the second metallic plate is the metallic plate having the tensile strength X2, and the third metallic plate is the metallic plate having the tensile strength X3.

The first metallic plate and the third metallic plate are situated at both ends of the workpiece W in the layering direction. The second metallic plate is disposed between the first metallic plate and the second metallic plate. The first metallic plate corresponds to the first steel plate P1 illustrated in FIG. 1. The second metallic plate corresponds to the second steel plate P2. The third metallic plate corresponds to the third steel plate P3. The first metallic plate, the second metallic plate, and the third metallic plate may respectively correspond to the third steel plate P3, the second steel plate P2, and the first steel plate P1. In other words, in understanding the first condition, the second condition, the third condition, and the fourth condition, the first metallic plate, the second metallic plate, and the third metallic plate may be understood as being layered from the top to the bottom or from the bottom to the top. In other words, the first metallic plate and the tensile strength X1 may be read as the third metallic plate and the tensile strength X3; and the third metallic plate and the tensile strength X3 may be read as the first metallic plate and the tensile strength X1.

The first condition is that the tensile strength X1 of the first metallic plate situated on a first end of the workpiece W is smaller than the tensile strength X3 of the third metallic plate situated on a second end of the workpiece W opposite from the first end. In other words, the first condition is that the two metallic plates situated at both ends of the workpiece W have different tensile strengths X1 and X3.

The second condition is that the tensile strength X1 of the first metallic plate situated at the first end of the workpiece W in the layering direction is larger than the tensile strength X2 of the second metallic plate situated in the middle of the workpiece W; and that the tensile strength X3 of the third metallic plate situated at the second end of the workpiece W in the layering direction is smaller than the sum of the tensile strength X1 of the first metallic plate and the tensile strength X2 of the second metallic plate. The second end of the workpiece W in the layering direction is the opposite end from the first end of the workpiece W in the layering direction.

The third condition is that the tensile strength X1 of the first metallic plate situated at the first end of the workpiece W is smaller than the tensile strength X2 of the second metallic plate situated in the middle of the workpiece W; and that the tensile strength X3 of the third metallic plate situated at the second end of the workpiece W is smaller than the sum of the tensile strength X1 of the first metallic plate and the tensile strength X2 of the second metallic plate.

In summary, the second condition and the third condition can be expressed as follows.

$$X 1 ⇆ X 2 and ( X 1 + X 2 ) > X 3$$

In other words, the second condition and the third condition are that the tensile strength X1 of the first metallic plate situated at the first end of the workpiece W is different from the tensile strength X2 of the second metallic plate situated in the middle of the workpiece W; and that the tensile strength X3 of the third metallic plate situated at the second end of the workpiece W is smaller than the sum of the tensile strength X1 of the first metallic plate and the tensile strength X2 of the second metallic plate.

The fourth condition is that two or more metallic plates are layered in the layering direction such that the tensile strength increases or decreases. The layering direction described herein includes the direction from the first metallic plate to the third metallic plate, and the direction from the third metallic plate to the first metallic plate.

The tensile strengths X1, X2, and X3 of the first condition, the second condition, the third condition, and the fourth condition may be read as resistances X1, X2, and X3. The tensile strength X1, X2, and X3 may be read as plate thicknesses X1, X2, and X3. The larger the tensile strength is, the larger the resistance is. The larger the plate thickness is, the larger the tensile strength is.

When the first condition is satisfied, the center of resistance of the workpiece W deviates toward the third metallic plate in the layering direction of the workpiece W due to the third metallic plate which has a large resistance. When the fourth condition is satisfied, the center of resistance of the workpiece W deviates toward the first metallic plate in the layering direction of the workpiece W due to the first metallic plate which has a large resistance.

Accordingly, in a method of growing the welding nugget G simply from the center of resistance provided by applying the conventional welding method to the workpiece W that satisfies any one of these conditions, an insufficient welding may occur in the metallic plates disposed at the ends of the workpiece W.

According to the present embodiment, as shown in FIG. 7A, it is possible to achieve the melt of the first metallic plate that has a relatively small resistance by supplying a large current, and to properly achieve the welding of the workpiece W. Thus, it is also possible to inhibit spatters.

The aforementioned first condition, second condition, third condition, and fourth condition are applicable in a case where the workpiece W is prepared by layering four or more metallic plates. In a case where the aforementioned conditions are satisfied when “the second metallic plate” is replaced with “a set of layered metallic plates” and “the tensile strength X2 of the second metallic plate” is replaced with a sum of the tensile strengths of the metallic plates included in “the set of layered metallic plates”, the method of the resistance spot welding of the present embodiment effectively functions for welding the workpiece W in an excellent manner. If the workpiece W is prepared by layering four or more metallic plates, “the second metallic plate situated in the middle of the workpiece W” in the second condition and the third condition is one or more metallic plates held between two metallic plates situated at both ends of the workpiece W. In this case, “the tensile strength X2 of the second metallic plate situated in the middle of the workpiece W” is the sum of the tensile strengths of one or more metallic plates held between two metallic plates situated at both ends of the workpiece W.

According to welding tests under various environments, it has been found that the method of resistance spot welding of the present embodiment contributes to appropriate welding of the workpiece W also when the workpiece W satisfies either one of the following fifth condition or sixth condition.
Fifth condition: difference ΔX in strengths on both ends is 445 MPa or more.
Sixth condition: difference ΔX in strengths on both ends is 255 MPa or more, and a ratio R of strengths between both ends is 4.29 or more.

The difference ΔX in strengths on both ends is a difference in tensile strengths of the metallic plates situated at both ends of the workpiece W in the layering direction. In other words, the difference ΔX in strengths on both ends is a difference in tensile strengths between two metallic plates of the workpiece W to which the pair of electrodes 21, 22 contact. By using the aforementioned tensile strengths X1, X2, and X3, the difference ΔX in strengths on both ends can be expressed in the following formula: ΔX=|X1-X3|.

The ratio R of strengths corresponds to the ratio R=R1/R2 where R1 is the sum of the tensile strengths of the metallic plates of the workpiece W in the layering direction, and R2 is the tensile strength of the metallic plate having a smaller tensile strength among the two metallic plates situated at both ends of the workpiece W including two or more metallic plates in the layering direction. By using the aforementioned tensile strengths X1, X2, and X3, R1 can be expressed in the following formula: R1=(X1+X2+X3). R2 can be expressed in the following formula: R2-min {X1, X3} by using MIN function. In this case, ratio R of strengths is expressed in the following formula:

$$R = ( X 1 + X 2 + X 3 ) / min \{ X 1 , X 3 \} .$$

As the difference ΔX in strengths on both ends increases, the melt of the metallic plate having a relatively small tensile strength does not proceed due to low resistance. As the ratio R of strengths increases, the welding nugget G is biased. Thus, the method of the resistance spot welding of the present embodiment is highly useful on the workpiece W that satisfies the aforementioned fifth condition and sixth condition.

The method of the resistance spot welding of the present embodiment also functions generally effectively when welding the workpiece W whose plate thickness satisfies the following seventh condition.
Seventh condition: ratio H of plate thickness is 3.5 or more.

The ratio H of plate thickness described herein is the ratio H1/H2 where H1 is the total plate thickness H1 which is the sum of the thicknesses of the metallic plates included in the workpiece W in the layering direction, and H2 is the thickness of the metallic plate having the smaller thickness among the two metallic plates situated at both ends of the workpiece W including the metallic plates in the layering direction.

### Modified Examples

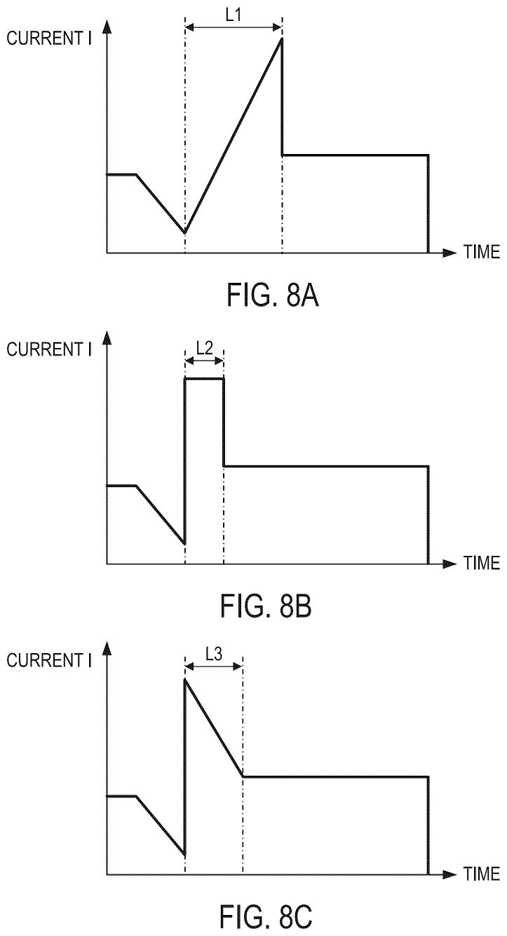

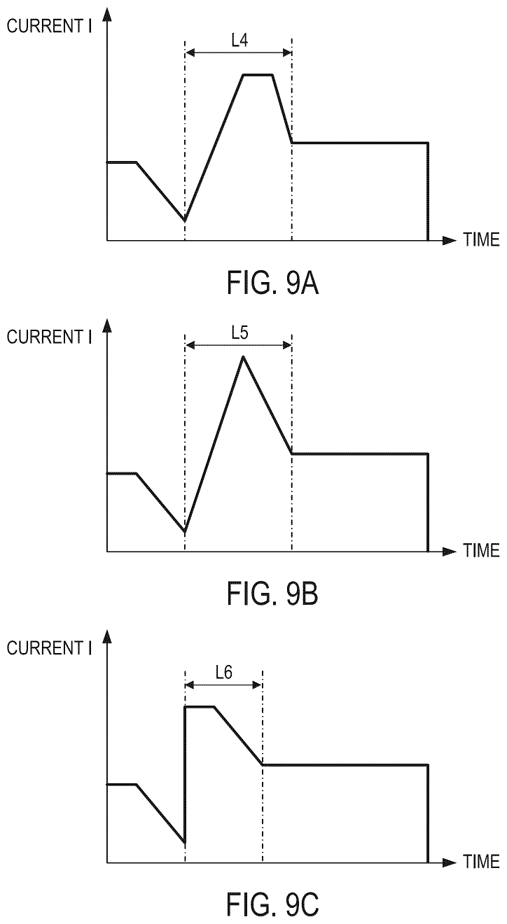

The current profile should not be limited to the example shown in FIG. 3 and may be modified to the current profile of any one of FIG. 8A, FIG. 8B, FIG. 8C, FIG. 9A, FIG. 9B, or FIG. 9C. As it can be understood from comparisons between FIG. 3 and FIG. 8A, FIG. 8B, FIG. 8C, FIG. 9A, FIG. 9B, and FIG. 9C, the initial current application including a down-slope and a large current before the main current application particularly contribute to an excellent welding.

In the current profile shown in FIG. 8A, the current waveform of the large current section L1 is a triangle shape having an up-slope and a sharp peak unlike the trapezoid shown in FIG. 3. In the current profile shown in FIG. 8B, the current waveform of the large current section L2 is a rectangular shape. In the current profile shown in FIG. 8C, the current waveform of the large current section L3 is a triangle shape having a down-slope beginning from the peak.

In the current profile shown in FIG. 9A, the current waveform of the large current section L4 is a trapezoid having an up-slope and a down-slope. In the current profile shown in FIG. 9B, the current waveform of the large current section L5 is a triangle shape having an up-slope, a down-slope, and a sharp peak. In the current profile shown in FIG. 9C, the current waveform of the large current section L6 is a trapezoid beginning from a peak.

### OTHER EMBODIMENTS

The present disclosure should not be limited to the aforementioned embodiments and may be embodied in various modes. For example, the aforementioned resistance spot welding apparatus 1 and method of resistance spot welding may be used in welding the workpiece W prepared by layering two metallic plates.

Functions of one element in the aforementioned embodiment may be distributed to two or more elements. Functions of two or more elements may be integrated into one element. A part of the configuration of the aforementioned embodiment may be omitted. At least a part of the configuration of the aforementioned embodiment may be added to or replaced with other configuration of the aforementioned embodiment. Any and all modes included in the technical idea specified by the languages used in the claims are the embodiments of the present disclosure.

### [Technical Ideas Disclosed in the Present Description]

It can be understood that the present disclosure discloses the following ideas.

### [Item 1]

Item 1 is a method of resistance spot welding for welding a workpiece prepared by layering two or more metallic plates by using a resistance spot welding apparatus including a pair of electrodes.

The method comprising:
performing a first current application control on the pair of electrodes such that a first current flows between the pair of electrodes in a state where the workpiece is held between the pair of electrodes at both ends of the workpiece in a layering direction of the two or more metallic plates;
performing a second current application control, subsequent to the first current application control, on the pair of electrodes such that a current flowing between the pair of electrodes decreases from the first current to a second current that is smaller than the first current;
performing a third current application control, subsequent to the second current application control, on the pair of electrodes such that a current flowing between the pair of electrodes increases from the second current to a third current that is greater than the second current; and
performing a fourth current application control, subsequent to the third current application control, on the pair of electrodes such that a fourth current flows between the pair of electrodes.

The fourth current is a constant current.

The first current is a constant current smaller than the fourth current.

The third current is greater than the fourth current.

### [Item 2]

Item 2 is the method of resistance spot welding according to item 1. The two or more metallic plates include at least two metallic plates having resistances, tensile strengths, or plate thicknesses different from one another.

### [Item 3]

Item 3 is the method of resistance spot welding according to item 1 or item 2. The workpiece includes a workpiece in which two metallic plates, among the two or more metallic plates, situated at the both ends of the workpiece in the layering direction have resistances, tensile strengths, or plate thicknesses different from one another.

### [Item 4]

Item 4 is the method of resistance spot welding according to any one of Item 1 to Item 3.

The workpiece includes at least one of the following (i) or (ii):
(i) a workpiece prepared by layering the two or more metallic plates such that the resistance, the tensile strength, or the plate thickness of the two or more metallic plates increase or decrease in the layering direction, or
(ii) a workpiece in which, among the two or more metallic plates, a tensile strength of a first metallic plate situated at a first end of the workpiece in the layering direction is different from a tensile strength of a second metallic plate situated in a middle of the workpiece in the layering direction; a tensile strength of a third metallic plate situated at a second end of the workpiece in the layering direction, which is an opposite end from the first end, is smaller than a sum of the tensile strength of the first metallic plate and the tensile strength of the second metallic plate; and the tensile strength of the second metallic plate situated in the middle of the workpiece in the layering direction is a tensile strength of a metallic plate held between the first metallic plate and the third metallic plate situated at the both ends of the workpiece in the layering direction among the two or more metallic plates, or a sum of tensile strengths of one or more metallic plates held between the first metallic plate and the third metallic plate among the two or more metallic plates.

### [Item 5]

Item 5 is the method of resistance spot welding according to any one of Item 1 to Item 4.

A ratio H1/H2 of a total plate thickness H1 which is a sum of thicknesses of the two or more metallic plates of the workpiece in the layering direction to a thickness H2 which is a thickness of a metallic plate having a smaller thickness among two metallic plates situated at both ends of the workpiece in the layering direction of the two or more metallic plates is 3.5 or more.

### [Item 6]

Item 6 is the method of resistance spot welding according to any one of

### Item 1 to Item 5.

The workpiece includes at least one of
a workpiece having a difference in strength of 445 MPa or more on the both ends, and
a workpiece having a difference in strength of 255 MPa or more on the both ends, and a ratio of strength of 4.29 or more between the both ends.

The difference in strength at the both ends is a difference in tensile strength of two metallic plates situated at the both ends of the workpiece in the layering direction. The ratio of strength is a value obtained by dividing a sum of the tensile strengths of the two or more metallic plates of the workpiece by a tensile strength of a metallic plate having a smaller tensile strength among the two metallic plates situated at the both ends of the workpiece in the layering direction.

### [Item 7]

Item 7 is the method of resistance spot welding according to any one of Item 1 to Item 6.

The two or more metallic plates include a high-tensile steel plate.

### [Item 8]

Item 8 is a resistance spot welding apparatus for welding a workpiece prepared by layering two or more metallic plates.

The apparatus comprising:
a pair of electrodes disposed to hold the workpiece at both ends of the workpiece in layering direction of the two or more metallic plates; and
a controller configured to control current application between the pair of electrodes.

The controller is configured to:
perform a first current application control on the pair of electrodes such that a first current flows between the pair of electrodes that hold the workpiece;
perform a second current application control, subsequent to the first current application control, on the pair of electrodes such that a current that flows between the pair of electrodes decreases from the first current to a second current that is smaller than the first current;
perform a third current application control, subsequent to the second current application control, on the pair of electrodes such that a current that flows between the pair of electrodes increases from the second current to a third current that is greater than the second current; and
perform a fourth current application control, subsequent to the third current application control, on the pair of electrodes such that a fourth current flows between the pair of electrodes.

The fourth current is a constant current.

The first current is a constant current smaller than the fourth current.

The third current is greater than the fourth current.

What is claimed is:

1. A method of resistance spot welding for welding a workpiece prepared by layering two or more metallic plates by using a resistance spot welding apparatus including a pair of electrodes, the method comprising:
performing a first current application control on the pair of electrodes such that a first current flows between the pair of electrodes in a state where the workpiece is held between the pair of electrodes at both ends of the workpiece in a layering direction of the two or more metallic plates;
performing a second current application control, subsequent to the first current application control, on the pair of electrodes such that a current flowing between the pair of electrodes decreases from the first current to a second current that is smaller than the first current;
performing a third current application control, subsequent to the second current application control, on the pair of electrodes such that a current flowing between the pair of electrodes increases from the second current to a third current that is greater than the second current; and
performing a fourth current application control, subsequent to the third current application control, on the pair of electrodes such that a fourth current flows between the pair of electrodes,
wherein the fourth current is a constant current,
wherein the first current is a constant current smaller than the fourth current, and
wherein the third current is greater than the fourth current.

2. The method of resistance spot welding according to claim 1,
wherein the two or more metallic plates include at least two metallic plates having resistances, tensile strengths, or plate thicknesses different from one another.

3. The method of resistance spot welding according to claim 1,
wherein the workpiece includes a workpiece in which two metallic plates, among the two or more metallic plates, situated at the both ends of the workpiece in the layering direction have resistances, tensile strengths, or plate thicknesses different from one another.

4. The method of resistance spot welding according to claim 1,
wherein the workpiece includes at least one of the following (i) or (ii):
(i) a workpiece prepared by layering the two or more metallic plates such that the resistance, the tensile strength, or the plate thickness of the two or more metallic plates increase or decrease in the layering direction, or
(ii) a workpiece in which, among the two or more metallic plates, a tensile strength of a first metallic plate situated at a first end of the workpiece in the layering direction is different from a tensile strength of a second metallic plate situated in a middle of the workpiece in the layering direction; a tensile strength of a third metallic plate situated at a second end of the workpiece in the layering direction, which is an opposite end from the first end, is smaller than a sum of the tensile strength of the first metallic plate and the tensile strength of the second metallic plate; and the tensile strength of the second metallic plate situated in the middle of the workpiece in the layering direction is a tensile strength of a metallic plate held between the first metallic plate and the third metallic plate situated at the both ends of the workpiece in the layering direction among the two or more metallic plates, or a sum of tensile strengths of one or more metallic plates held between the first metallic plate and the third metallic plate among the two or more metallic plates.

5. The method of the resistance spot welding according to claim 1,
wherein a ratio H1/H2 of a total plate thickness H1 which is a sum of thicknesses of the two or more metallic plates of the workpiece in the layering direction to a thickness H2 which is a thickness of a metallic plate having a smaller thickness among two metallic plates situated at the both ends of the workpiece in the layering direction of the two or more metallic plates is 3.5 or more.

6. The method of resistance spot welding according to claim 1,
wherein the workpiece includes at least one of
a workpiece having a difference in strength of 445 MPa or more on the both ends, or
a workpiece having a difference in strength of 255 MPa or more on the both ends, and a ratio of strength of 4.29 or more between the both ends, and
wherein the difference in strength at the both ends is a difference in tensile strengths of two metallic plates situated at the both ends of the workpiece in the layering direction, and the ratio of strength is a value obtained by dividing a sum of the tensile strengths of the two or more metallic plates of the workpiece by a tensile strength of a metallic plate having a smaller tensile strength among the two metallic plates situated at the both ends of the workpiece in the layering direction.

7. The method of resistance spot welding according to claim 1,
wherein the two or more metallic plates include a high-tensile steel plate.

8. A resistance spot welding apparatus for welding a workpiece prepared by layering two or more metallic plates, the apparatus comprising:
a pair of electrodes disposed to hold the workpiece at both ends of the workpiece in a layering direction of the two or more metallic plates; and
a controller configured to control current application between the pair of electrodes,
wherein the controller is configured to:
perform a first current application control on the pair of electrodes such that a first current flows between the pair of electrodes that holds the workpiece;
perform a second current application control, subsequent to the first current application control, on the pair of electrodes such that a current that flows between the pair of electrodes decreases from the first current to a second current that is smaller than the first current;
perform a third current application control, subsequent to the second current application control, on the pair of electrodes such that a current that flows between the pair of electrodes increases from the second current to a third current that is greater than the second current; and
perform a fourth current application control, subsequent to the third current application control, on the pair of electrodes such that a fourth current flows between the pair of electrodes,
wherein the fourth current is a constant current,
wherein the first current is a constant current smaller than the fourth current, and
wherein the third current is greater than the fourth current.
